(19) United States
(12) Patent Application Publication
(10) Pub. No.: US 2019/0013955 A1
(43) Pub. Date: Jan. 10, 2019

(54) ONLINE CONFERENCE SYSTEM

(71) Applicant: CORENTEC CO., LTD., Chungchengnam-do (KR)

(72) Inventor: Oui-Sik Yoo, Seoul (KR)

(21) Appl. No.: 15/818,256

(22) Filed: Nov. 20, 2017

(30) Foreign Application Priority Data
Jul. 5, 2017 (KR) 10-2017-0085514

(51) Int. Cl. H04L 12/18

(52) U.S. Cl. CPC H04L 12/1822

(57) ABSTRACT

An online conference system includes: a pre-conference management module storing and managing information of a scheduled online conference before processing the online conference; a conference process module generating information of an ongoing conference when processing the online conference; and a post-conference management module storing and managing information of a finished online conference after processing the online conference.

### CROSS REFERENCE TO RELATED APPLICATION

The present application claims priority to Korean Patent Application No. 10-2017-0085514, filed Jul. 05, 2017, the entire contents of which is incorporated herein for all purposes by this reference.

### BACKGROUND OF THE INVENTION

### Field of the Invention

The present invention generally relates to an online conference system. More particularly, the present invention relates to an online conference system wherein preparation, process, and post-conference management of an online conference are systematically and efficiently performed by including: a pre-conference management module storing and managing information of a scheduled online conference before processing the online conference; a conference process module generating information of an ongoing conference when processing the online conference; and a post-conference management module storing and managing information of a finished online conference after processing the online conference.

### Description of the Related Art

In many cases of medical devices such as biocompatible implants and surgical instruments, developments thereof are designed to be exported to the United States or other countries, and FDA regulations, for example, require keeping decision-making records at each stage of the development process. In other words, it is very important to operate design review conferences related to improvements of medical devices and to maintain records of expert reviews. However, the development of medical devices is often carried out in collaboration with overseas institutions and researchers, which makes it difficult to hold such conferences in terms of time and cost.

Meanwhile, recently, due to the development of the Internet and communication technologies, online conferences are widely used rather than holding a conference in which participants actually attend the conference. Use of online conferences in the development of medical devices may save a much time and money. However, online conferences are not widely used in relation to the development of medical devices because conventional solutions related to online conferences have the following problems.

First, conventional online conference solutions are focused on smoothly conducting a multi-lateral conference by configuring a conference room in an online environment. Accordingly, enabling sufficient previewing of an agenda of the conference or pre-mediations between participants of the conference may be difficult when using a conventional online conference solution.

In addition, conventional online conference solutions do not specifically provide post-conference review and management of the agenda discussed in the online conference after the online conference. As a result, it may cause inconvenience since the post-conference review and management may need to be performed by using an additional means.

In addition, conventional online conference solutions do not manage voting on an agenda discussed in the online conference nor provide quantitative information related to a conference process or conclusion, thus productivity and efficiency of conducting the conference may be reduced.

In addition, conventional online conference solutions do not provide functions for the inputting anonymous comments in the online conference. Accordingly, minority opinions or off-the-record opinions for the development process are not readily presented.

Due to limit of the conventional online conference solutions described above, online conferences are not yet widely used in the development of medical devices yet. In conferences related to the development of medical devices, frequently, a sufficient preview of agendas and post-conference management may be required, and deriving a quantitative conclusion such as voting on an agenda, the collection of agenda voting results or the expressing of anonymous opinions may be required. However, it may be difficult to conduct an effective online conference by using conventional online conference solutions.

In such a situation, there is a growing need to develop a technique that overcomes the problems of a conventional online solution, in other words, a technology that enables online conferences related to the development of medical devices to be smoothly conducted.

The foregoing is intended merely to aid in the understanding of the background of the present invention, and is not intended to mean that the present invention falls within the purview of the related art that is already known to those skilled in the art.

### Documents of Related Art

(Patent Document 1) Korea Patent No. 10-0859788 (Electronic conference support device, electronic conference support method, and information terminal device of electronic conference system, Registration Date: Sep. 17, 2008)

### SUMMARY OF THE INVENTION

Accordingly, the present invention has been made keeping in mind the above problems occurring in the related art, and the present invention is intended to propose an online conference system that enables a participant to sufficiently preview an online conference agenda before the online conference, and manage and review a post-conference status of a conference result of the online conference after the online conference.

Another object of the present invention is to provide an online conference system whereby an online conference may be conducted to derive a quantitative conclusion.

Still another object of the present invention is to provide an online conference system whereby an attendance request may be transmitted to a participant before an online conference, and the participant may review conference data and an agenda of the online conference.

Still another object of the present invention is to provide an online conference system whereby attendance of a participant is accurately checked by using an electronic identification or a biometric recognition method of the participant in the ongoing online conference.

Still another object of the present invention is to provide an online conference system whereby process progress information of the online conference is quantitatively generated in the ongoing online conference.

Still another object of the present invention is to provide an online conference system whereby, in the ongoing online conference, a voting interface for an agenda is provided, and an agenda voting result is collected.

Still another object of the present invention is to provide an online conference system whereby, a conference record is generated by performing voice recording or video recording in the ongoing online conference.

Still another object of the present invention is to provide an online conference system whereby, in the ongoing online conference, an off-the-record statement may be input by stopping the generation of the conference record by a conference record generation part under a certain condition.

Still another object of the present invention is to provide an online conference system whereby, an anonymous comment may be input from the participant in the ongoing online conference.

Still another object of the present invention is to provide an online conference system whereby an additional agenda may be newly generated in the ongoing online conference.

Still another object of the present invention is to provide an online conference system whereby a conference result including the agenda voting result conducted in the online conference is stored and managed after the online conference.

Still another object of the present invention is to provide an online conference system whereby a post-conference management of a process status related to the conference result and a management of the additional agenda is performed after the online conference.

In order to achieve the above object, the present invention is implemented by an embodiment having the following configuration.

According to an embodiment of the present invention, an online conference system of the present invention includes: a pre-conference management module storing and managing information of a scheduled online conference before processing the online conference; a conference process module generating information of an ongoing conference when processing the online conference; and a post-conference management module storing and managing information of a finished online conference after processing the online conference.

According to another embodiment of the present invention, in the online conference system of the present invention, the pre-conference management module may include a participant management part storing and managing information of a participant who will attend the online conference.

According to another embodiment of the present invention, in the online conference system of the present invention, the participant management part may include an attendance request transmitting part transmitting an attendance request to the participant who will attend the online conference.

According to another embodiment of the present invention, in the online conference system of the present invention, the pre-conference management module may include a pre-conference data management part storing and managing conference data that will be handled in the online conference.

According to another embodiment of the present invention, in the online conference system of the present invention, the pre-conference management module may further include an agenda management part storing and managing a voting subject agenda of the online conference.

According to another embodiment of the present invention, in the online conference system of the present invention, the pre-conference management module may further include a preview reply management part storing and managing any one or more of a reply of the participant for the attendance request and a comment of the participant for the agenda.

According to another embodiment of the present invention, in the online conference system of the present invention, the conference process module may include a participant check part checking an attendance of the participant.

According to another embodiment of the present invention, in the online conference system of the present invention, the participant check part may include a participant authorization part checking the attendance of the participant by using an electronic identification or a biometric authorization method.

According to another embodiment of the present invention, in the online conference system of the present invention, the conference process module may further include a conference process management part generating and providing process progress information of the ongoing online conference.

According to another embodiment of the present invention, in the online conference system of the present invention, the conference process management part may include a process progress display part quantitatively displaying the process progress information.

According to another embodiment of the present invention, in the online conference system of the present invention, the conference process module may further include an agenda voting management part providing a voting interface for the agenda of the ongoing online conference, and collecting a voting result.

According to another embodiment of the present invention, in the online conference system of the present invention, the conference process module may further include a conference record generation part generating a conference record of the ongoing online conference.

According to another embodiment of the present invention, in the online conference system of the present invention, the conference record generation part may include any one or more of a voice recording part performing voice recording and a video recording part performing video recording.

According to another embodiment of the present invention, in the online conference system of the present invention, the conference process module may further include an off-the-record statement management part stopping, under a certain condition, the generation of the conference record performed by the conference record generation part.

According to another embodiment of the present invention, in the online conference system of the present invention, the conference process module may further include a comment management part receiving a comment from a participant anonymously or by name.

According to another embodiment of the present invention, in the online conference system of the present invention, the conference process module may further include an additional agenda generation part generating an additional agenda that is newly generated in the ongoing online conference.

According to another embodiment of the present invention, in the online conference system of the present invention, the post-conference management module may include a conference result management part storing and managing a conference result including any one or more of the agenda voting result collected by the agenda voting management part, the conference record generated by the conference record generation part, and the comment received by the comment management part.

According to another embodiment of the present invention, in the online conference system of the present invention, the conference result management part may include a minutes generation part generating a minutes based on the conference record.

According to another embodiment of the present invention, in the online conference system of the present invention, the post-conference management module may further include a post-conference status management part storing and managing post-conference process status information related to the conference result.

According to another embodiment of the present invention, in the online conference system of the present invention, the post-conference management module may further include an additional agenda management part storing and managing the additional agenda generated by the additional agenda generation part.

According to another embodiment of the present invention, in the online conference system of the present invention, the post-conference management module may further include a post-conference review reply management part receiving post-conference comment input related to the finished online conference from the participant, and storing and managing the received comment.

According to another embodiment of the present invention, in the online conference system of the present invention, the post-conference management module may further include a post-conference data management part storing and managing conference data handled in the online conference.

According to another embodiment of the present invention, the online conference system of the present invention may further include a conference host terminal including: a pre-conference management interface providing module providing a management interface for the pre-conference management module; a conference process management interface providing module providing a management interface for the conference process module; and a post-conference management interface providing module providing a management interface for the post-conference management module.

According to another embodiment of the present invention, in the online conference system of the present invention, the pre-conference management interface providing module may include: a participant management interface proving part providing a management interface for information of the participant who will attend the online conference; a pre-conference data management interface providing part providing a management interface for the conference data that will be handled in the online conference; and an agenda management interface providing part providing a management interface for the voting subject agenda of the online conference.

According to another embodiment of the present invention, in the online conference system of the present invention, the conference process management interface providing module may include an agenda voting management interface providing part providing a management interface related to an agenda voting performed in the online conference.

According to another embodiment of the present invention, in the online conference system of the present invention, the conference process management interface providing module may further include a comment management interface providing part providing a comment management interface so that the participant of the online conference anonymously inputs a comment for the ongoing online conference.

According to another embodiment of the present invention, in the online conference system of the present invention, the conference process management interface providing module may further include an additional agenda generation interface providing part providing a generation interface for the additional agenda generated in the ongoing online conference.

According to another embodiment of the present invention, in the online conference system of the present invention, the post-conference management interface providing module may include: a conference result management interface providing part providing a management interface for the conference result of the finished online conference; a post-conference status management interface providing part providing a management interface for a post-conference status item that requires a post-conference action among the conference results of the finished online conference; and an additional agenda management interface providing part providing a management interface for the generated additional agenda of the finished online conference.

According to another embodiment of the present invention, the online conference system of the present invention may further include a participant terminal including: a pre-conference interface providing module provided with information of the scheduled online conference from the pre-conference management module; a conference interface providing module provided with information of the ongoing online conference from the conference process module; and a post-conference interface providing module provided with information of the finished online conference from the post-conference management module.

According to an embodiment of the present invention, in the online conference system of the present invention, the pre-conference interface providing module may include: a pre-conference data interface providing part providing an interface to the participant for checking the conference data that will be handled in the online conference; and an agenda interface providing part providing an interface to the participant for pre-checking the voting subject agenda that will be voted in the scheduled online conference.

According to another embodiment of the present invention, in the online conference system of the present invention, the conference interface providing module may include an agenda voting interface providing part providing an interface to the participant for voting on the agenda of the ongoing online conference.

According to another embodiment of the present invention, in the online conference system of the present invention, the conference interface providing module may further include a comment interface providing part providing an interface to the participant of online conference for anonymously inputting a comment of the ongoing online conference.

According to another embodiment of the present invention, in the online conference system of the present invention, the post-conference interface providing module may include: a conference result interface providing part providing an interface to the participant for checking the conference result of the finished online conference; and a post-conference status interface providing part providing an interface to the participant for checking a post-conference status related to the conference result of the finished online conference.

The present invention has the following effects through the above-described configuration.

The present invention has an effect of providing an online conference system that enables a participant to sufficiently preview an online conference agenda before the online conference, and to manage and review a post-conference status of a conference result of the online conference after the online conference.

The present invention has an effect of providing an online conference system whereby an online conference may be conducted to derive a quantitative conclusion.

The present invention has an effect of providing an online conference system whereby an attendance request may be transmitted to a participant before the online conference, and the participant may review conference data and an agenda of the online conference.

The present invention has an effect of providing an online conference system whereby an attendance of the participant is accurately checked by using an electronic identification or a biometric recognition method of a participant in an ongoing online conference.

The present invention has an effect of providing an online conference system whereby, in the ongoing online conference, process progress information of an online conference is quantitatively generated.

The present invention has an effect of providing an online conference system whereby, in the ongoing online conference, a voting interface for an agenda is provided, and an agenda voting result is collected.

The present invention has an effect of providing an online conference system whereby, in the ongoing online conference, a conference record is generated by performing voice recording or video recording.

The present invention has an effect of providing an online conference system whereby, in the ongoing online conference, an off-the-record statement may be input by stopping the generation of the conference record by a conference record generation part under a certain condition.

The present invention has an effect of providing an online conference system whereby, in the ongoing online conference, an anonymous comment may be input from a participant.

The present invention has an effect of providing an online conference system whereby an additional agenda may be newly generated in the ongoing online conference.

The present invention has an effect of providing an online conference system whereby a conference result including the agenda voting result conducted in the online conference is stored and managed after the online conference.

The present invention has an effect of providing an online conference system wherein a post-conference management of a process status related to the conference result and a management of the additional agenda are performed after the online conference.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a configuration diagram of an online conference system according to an embodiment of the present invention;

FIG. 2 is a configuration diagram of a conference server of the online conference system according to the embodiment of the present invention;

FIG. 3 is a configuration diagram of a pre-conference management module of the conference server of the online conference system according to the embodiment of the present invention;

FIG. 4 is a view showing an example of information stored and managed by the pre-conference management module of the conference server of the online conference system according to the embodiment of the present invention, and which is displayed by using an application program that is installed and executed in a participant terminal;

FIG. 5 is a configuration diagram of a conference process module of the conference server of the online conference system according to the embodiment of the present invention;

FIGS. 6 and 7 are views showing examples of information generated by the conference process module of the conference server of the online conference system according to the embodiment of the present invention, and which is displayed by using the application program that is installed and executed in the participant terminal;

FIG. 8 is a configuration diagram of a post-conference management module of the conference server of the online conference system according to the embodiment of the present invention;

FIG. 9 is a view showing information stored and managed by the post-conference management module of the conference server of the online conference system according to the embodiment of the present invention, and which is displayed by using the application program that is installed and executed in the participant terminal;

FIG. 10 is a configuration diagram of a general management module of the conference server of the online conference system according to the embodiment of the present invention;

FIG. 11 is a configuration diagram of a conference host terminal of the online conference system according to the embodiment of the present invention;

FIG. 12 is a configuration diagram of a pre-conference management interface providing module of the conference host terminal of the online conference system according to the embodiment of the present invention;

FIG. 13 is a configuration diagram of a conference process management interface providing module of the conference host terminal of the online conference system according to the embodiment of the present invention;

FIG. 14 is a configuration diagram of a post-conference management interface providing module of the conference host terminal of the online conference system according to the embodiment of the present invention;

FIG. 15 is a configuration diagram of a general management interface providing module of the conference host terminal of the online conference system according to the embodiment of the present invention;

FIG. 16 is a of a configuration diagram of the participant terminal of the online conference system according to the embodiment of the present invention;

FIG. 17 is a configuration diagram of a pre-conference interface providing module of the participant terminal of the online conference system according to the embodiment of the present invention;

FIG. 18 is a configuration diagram of a conference process interface providing module of the participant terminal of the online conference system according to the embodiment of the present invention;

FIG. 19 is a configuration diagram of a post-conference interface providing module of the participant terminal of the online conference system according to the embodiment of the present invention;

FIG. 20 is a configuration diagram of a general interface providing module of the participant terminal of the online conference system according to the embodiment of the present invention; and

FIG. 21 is a view showing an example of an online conference procedure performed in the online conference system according to the embodiment of the present invention.

### DETAILED DESCRIPTION OF THE INVENTION

Hereinbelow, an online conference system according to the present invention will be described in detail with reference to the accompanying drawings. Unless otherwise defined, all terms including technical and scientific terms used herein have the same meaning as commonly understood by one of ordinary skill in the art to which this invention belongs. When terms used herein differ from the commonly understood meaning, the terms will be interpreted as defined herein. In the following description of the present invention, detailed descriptions of known functions and components incorporated herein will be omitted when it may make the subject matter of the present invention unclear.

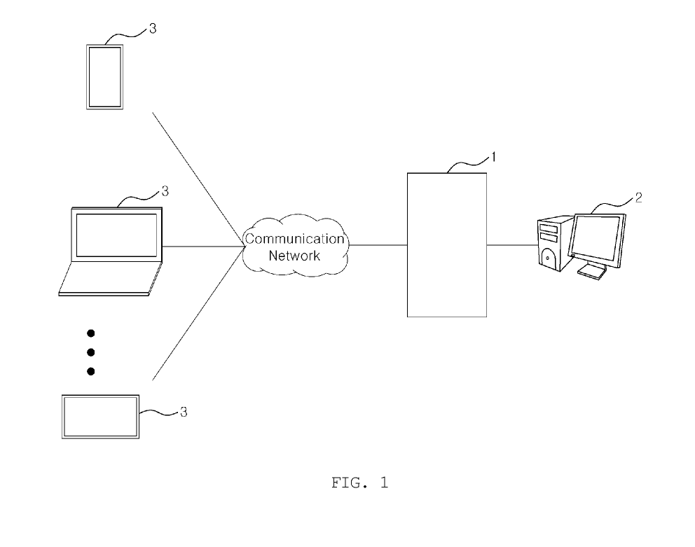

FIG. 1 is a configuration diagram of an online conference system according to an embodiment of the present invention. Referring to FIG. 1, the online conference system according to the embodiment of the present invention includes a conference server 1, a conference host terminal 2, and a participant terminal 3.

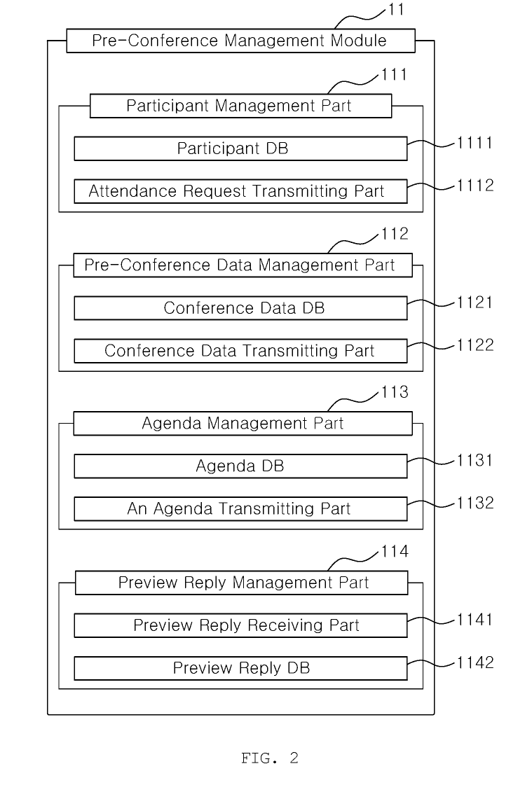

The conference server 1 stores, manages, and processes various types of information for operating the online conference system. FIG. 2 is a configuration diagram of the conference server 1 of the online conference system according to the embodiment of the present invention. Referring to FIG. 2, the conference server 1 includes a pre-conference management module 11, a conference process module 12, a post-conference management module 13, and a general management module 14.

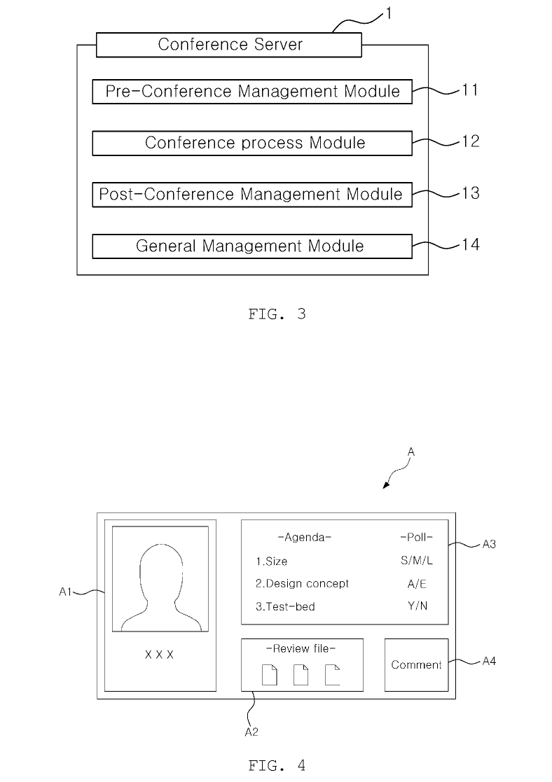

FIG. 3 shows a configuration diagram of the pre-conference management module 11 of the conference server 1 of the online conference system according to the embodiment of the present invention. In addition, FIG. 4 shows an example of information that is stored and managed by the pre-conference management module 11, and which is displayed by using an application program installed and executed in a participant terminal.

The pre-conference management module 11 is a module that stores and manages information of a scheduled online conference. Referring to FIG. 3, the pre-conference management module 11 may include a participant management part 111, a pre-conference data management part 112, an agenda management part 113, and a preview reply management part 114.

The participant management part 111 is a part that stores and manages information of a participant who will attend the online conference. The participant management part 111 may include a participant DB 1111, and an attendance request transmitting part 1112.

The participant DB 111 is a database that stores information of the participant. The participant DB 111 may store a name, a department, an e-mail, terminal identification information, etc. of each participant.

The attendance request transmitting part 1112 transmits an attendance request to the participant who will attend the online conference. The attendance request may be performed in various methods such as transmitting an e-mail, a text message, etc. As described above, when the participant uses the application program installed in his or her terminal as an interface for executing the present invention, an app alarm method may be used for transmitting the attendance request.

The pre-conference data management part 112 stores and manages conference data that will be handled in the online conference. The pre-conference data management part 112 may include a conference data DB 1121, and a conference data transmitting part 1122.

The conference data DB 1121 is a database storing conference data that will be handled in the online conference. The conference data DB 1121 may include document data, multi-media data, etc. which are related to the conference.

The conference data transmitting part 1122 transmits conference data to the participant who will attend the online conference. The transmission of the conference data may be performed by using various methods such transmitting an e-mail, etc. As described above, when the participant uses the application program installed in his or her terminal as the interface for executing the present invention, the conference data may be uploaded in and shared through a conference data interface provided by the application program. In detail, as shown in FIG. 4, when an online pre-conference interface is provided on an app window A of the participant terminal in which the application program is installed, the conference data transmitting part 1122 may provide a conference data providing interface as displayed in a lower central part A2 of the app window A while the authorization of the participant is performed through logging-in as shown in a left side A1 of the app window A. It may be configured that the participant may store the conference data transmitted from the conference data transmitting part 1122 in his or her participant terminal 3.

The agenda management part 113 stores and manages a voting subject agenda of the online conference. The agenda management part 113 may include an agenda DB 1131, and an agenda transmitting part 1132.

The agenda DB 1131 is a database that stores an agenda that will be discussed in the online conference. When the present invention is applied to an online conference related to a development of a medical device, in general, each participant is typically asked to vote on an issue. The agenda refers to a subject discussed and voted for the online conference.

The agenda transmitting part 1132 transmits the agenda to the participant who will attend the online conference. The transmission of the agenda may be performed by using various methods such as transmitting an e-mail, etc. As described above, when the participant uses the application program installed in his or her terminal as the interface for executing the present invention, the agenda that will be discussed in the online conference may be uploaded and shared by using an agenda providing interface provided by the application program. In detail, as shown in FIG. 4, when the online pre-conference interface is provided on the app window A of the participant terminal in which the application program is installed, the agenda transmitting part 1132 may provide an agenda transmission interface as shown in a right upper part A3 of the app window A while the authentication of the participant is performed through logging-in as shown in the left part A1 of the app window A. It may be configured that the participant may store the agenda transmitted by the agenda transmitting part 1132 is his or her participant terminal 3.

The preview reply management part 114 stores and manages any one or more of a reply of the participant for the attendance request, and a comment of participant for the agenda. The preview reply management part 114 may include a preview reply receiving part 1141, and a preview reply DB 1142.

The preview reply receiving part 1141 receives any one or more of the reply of the online conference participant for the attendance request, and the comment for the agenda from the participant who will attend the online conference. The preview reply receiving part 1141 receives the reply for the attendance request and the comment for the agenda from the participant terminal. As described above, when the participant uses the application program installed in his or her terminal as the interface for executing the present invention, the replay for the attendance request and the comment for the agenda may be input by using a pre-view reply interface provided by the application program. The comment for the agenda may be input anonymously or by name. In detail, as shown in FIG. 4, when the online pre-conference interface is provided on the app window A of the participant terminal in which the application program is installed, the preview reply receiving part 1141 may receive pre-comment input by clicking a preview input button A4 as shown in a lower right part of the app window A while the authentication of the participant is performed through logging-in as shown in the left part A1 of the app window A.

The preview reply DB 1142 is a database that stores any one or more of the reply for the attendance request and the comment for the agenda received by the preview reply receiving part 1141. The comment for the agenda may be stored anonymously or by name. It may be set so that a conference host who conducts the online conference may have the authority to check which participant has anonymously input the comment for the agenda

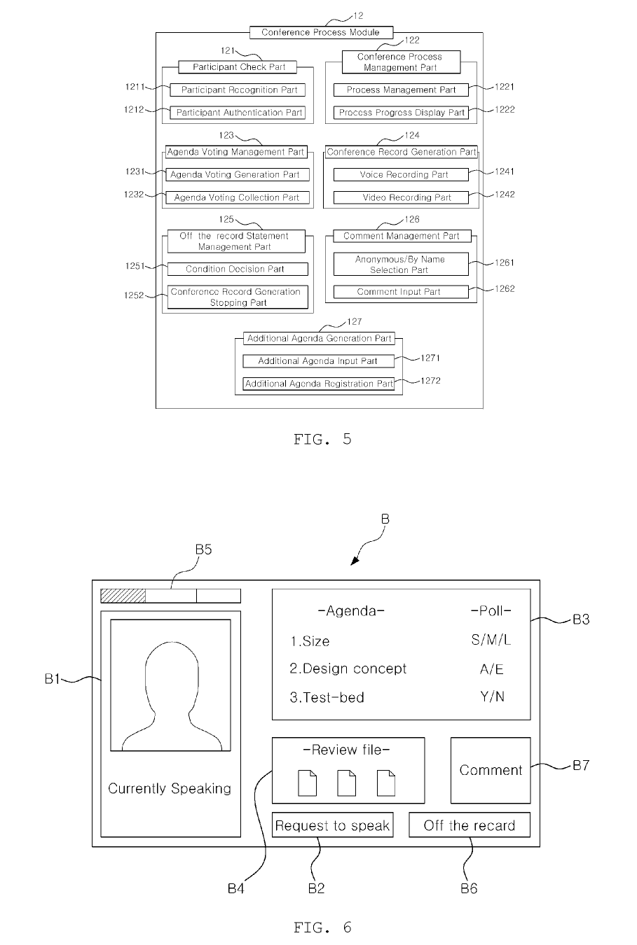

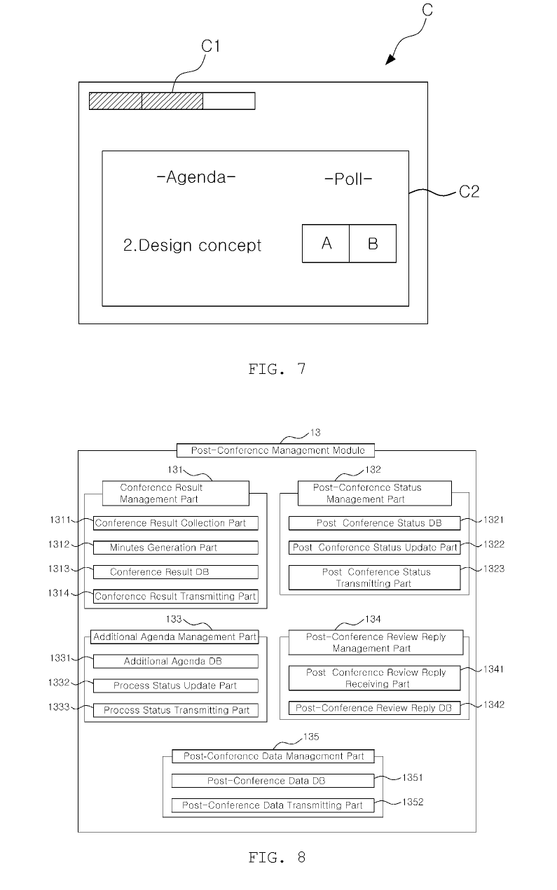

FIG. 5 shows a configuration diagram of the conference process module 12 of the conference server 1 of the online conference system according to the embodiment of the present invention, and FIGS. 6 and 7 are views showing examples of information generated by the conference process module 2, and which is displayed by using the application program installed in the participant terminal.

The conference process module 12 is a module that generates online conference information of an ongoing online conference. Referring to FIG. 5, the conference process module 12 may include a participant check part 121, a conference process management part 122, an agenda voting management part 123, a conference record generation part 124, an off-the-record statement management part 125, a comment management part 126, and an additional agenda generation part 127.

The participant check part 121 checks an attendance of the participant of the ongoing online conference. The participant check part 121 may include a participant recognition part 1211, and a participant authentication part 1212.

The participant recognition part 1211 recognizes the participant who has attended in the ongoing online conference. When the participant uses the application program installed in his or her terminal as the interface for executing the present invention, the participant may attend a virtual conference room of the ongoing online conference by using the application program. The participant recognition part 1211 recognizes the attended participant.

The participant authentication part 1212 checks the attendance of the participant by using an electronic identification or a biometric recognition method. In the conference on the development of medical devices, it is necessary to keep the security and the attendance record of the participant who is the expert in the field. For this, the participant authentication part 1212 checks the attendance of the participant who attends the online conference, in other words, performs an authentication of the participant. As the electronic identification, a public certificate, I-PIN authentication, etc. may be used. As the biometric recognition method, a fingerprint or iris recognition method may be used.

The conference process management part 122 generates and provides process progress information of the ongoing online conference. The conference process management part 122 may include a process management part 1221, and a process progress display part 1222.

The process management part 1221 manages an event related to the online conference occurring in the ongoing online conference such as a statement request, displaying a speaker, etc. The process management part 1221 provides an interface related to the online conference on the app window of the participants when the participants attend the online conference by using the application program. Describing in detail, as shown in FIG. 6, when the online conference interface is provide on an app window B of the participant terminal in which the application program is installed, the process management part 1221 displays a current speaker as shown in a left part B1 of the app window B, and performs a corresponding respond when a statement request button B2 of a lower central part of the app window B is clicked. In addition, the process management part 1221 may display a currently discussing agenda as shown in an upper right part B3 of the app window B, or provide an interface for checking conference data as shown in a central part B4 of the app window B.

The process progress display part 1222 generates and displays process progress information of the ongoing online conference. The online conference may be efficiently conducted since the participants may check a progress state of the online conference by the process progress display part 1222. It is preferable for the process progress display part 1222 to quantitatively display the process progress information. In FIGS. 6 and 7, progress bars B5 and C1 showing progress states are respectively shown in upper parts of the App windows. In FIG. 6, the progress bar B5 represents that a first agenda among three agendas is being discussed, and in FIG. 7, the progress bar C1 represents a second agenda is being discussed (voting on the second agenda is currently in progress)

The agenda voting management part 123 provides a voting interface for the agenda of the ongoing online conference, and collects agenda voting results. The agenda voting management part 123 may include an agenda voting generation part 1231, and an agenda voting collection part 1232.

The agenda voting generation part 1231 generates and provides an interface through which the participant votes on an agenda when a discussion for the agenda is made in the ongoing online conference. FIG. 7 shows a voting interface C2 for a design concept which is the second agenda discussed in the online conference. The participant may select a preferred one of the case A and the case B.

If necessary, voting on the agenda may be performed anonymously or by name. When voting by name is necessary, the agenda voting generation part 1231 may generate a name by voting interface in which identification information of the participants and agenda voting content are transferred to the agenda voting collection part 1232 when the participants vote on the agenda. Alternatively, when anonymous voting is necessary, the agenda voting generation part 1231 may generate an anonymous voting interface in which agenda voting content, except for identification information of the participants, is transferred to the agenda voting collection part 1232 when the participants vote on the agenda.

The agenda voting collection part 1232 collects agenda voting results performed in the ongoing online conference. As an example shown in FIG. 7, when a number of participants of the ongoing online conference is 5, and three participants have selected the case A, and two participants have selected the case B, the agenda voting collection part 1232 collects the above voting results. As described above, voting results for respective agendas of the ongoing online conference may be collected by the agenda voting collection part 1232, thus, the conclusion of the online conference may be quantitatively derived.

As described above, voting on the agenda may be performed anonymously or by name as necessary. For this, the agenda voting generation part 1231 may respectively generate the name by voting interface and the anonymous voting interface. Alternatively, the agenda voting generation part 1231 may generate a single voting interface, and collects the voting results anonymously or by name. Alternatively, the agenda voting collection part 1232 may collect the voting result anonymously as necessary, and may be set so that the voting result of each participant, in other words, information about the participant to which case has been voted for the agenda, may be checked only by the conference host who has the authority

The conference record generation part 124 generates a conference record of the ongoing online conference. The conference record generation part 124 may include a voice recording part 1241, and a video recording part 1242.

The voice recording part 1241 records statements of the participants of the ongoing online conference, and the video recording part 1242 records videos of the participants with the statements of the participants. The voice recording part 1241 and video recording part 1242 generate a conference record with a multi-media form, thus, a reliable conference record may be recorded.

The off-the-record statement management part 125 stops the generation of the conference record performed by the conference record generation part 124 under a certain condition. The off-the-record statement management part 125 may include a condition decision part 1251, and a conference record generation stopping part 1252. In the conference on the development of medical devices, a sensitive subject, such as an evaluation of a competitor's product, may cause a difficult situation when known to the outside, thus the off-the-record statement management part 125 stops the generation of the conference record performed by the conference record generation part 124, thereby enabling smooth continuation of the online conference.

The condition decision part 1251 stops the generation of the conference record performed by the conference record generation part 124, and determines whether or not a condition to make an off-the-record statement is satisfied. The above condition is not necessarily special, and in the simplest case, the condition may occur when an off-the-record statement request button B6 is clicked in the app window as shown in FIG. 6. In other words, according to the characteristic of the online conference, conditions to generate off-the-record statements may be variously and additionally performed in addition to the clicking of the off-the-record statement request button B6.

The conference record generation stopping part 1252 stops the operation of the conference record generation part 124 when the condition decision part 1251 determines that the condition for generating the off-the-record statement is satisfied (for example, when the off-the-record statement request button B6 is clicked). The conference record generation stopping part 1252 stops the operation of the voice recording part 1241 and the video recording part 1242 which are included in the conference record generation part 124 so that a conference record for the off-the-record statement is not generated.

The comment management part 126 receives comment input from the participant anonymously or by name. The comment management part 126 may include an anonymous/by name selection part 1261, and a comment input part 1262.

The anonymous/by name selection part 1261 provides an interface through which the participant may select to input the comment anonymously or by name when the participant of the ongoing online confer wants to input the comment. As shown in FIG. 6, when an online conference application is being executed and a comment input button B7 of the app window is clicked by the participant, the anonymous/by name selection part 1261 may preferentially provide a selection interface.

In many cases, the participant may not directly express his or her opinion due to relationships between parities related to the development of the medical device. The anonymous/by name selection part 1261 solves this problem by providing the interface through which the participants may input his or her comment anonymously or by name. If necessary, it may be set that the anonymous input comment may be checked by the conference host of the ongoing online conference.

The comment input part 1262 provides an interface through which the participant of the ongoing online conference may input the comment for the agenda. The comment input part 1262 may provide a text input window as the interface.

The additional agenda generation part 127 generates an additional agenda that refers to an agenda newly generated in the ongoing online conference. The additional agenda generation part 127 may include an additional agenda input part 1271, and an additional agenda registration part 1272. Generally, in a conference on the development of medical devices, during the discussion of the scheduled agenda, an additional agenda related to the scheduled agenda may be frequently generated. Continuity and efficiency of the conference may be ensured since the additional agenda generation part 127 makes the newly generated agenda to be managed as a newly discussing agenda.

The additional agenda input part 1271 provides an interface capable of inputting an agenda when an agenda is newly generated in the ongoing online conference. According to circumstances, the additional agenda input part 1271 may be configured to be accessed only by the conference host.

The additional agenda registration part 1272 registers an agenda newly input through the additional agenda input part 1271, in other words, an additional agenda. The additional agenda registration part 1272 stores the additional agenda in an additional agenda DB 1331 that will be described later. Meanwhile, content of the additional agenda may be displayed on the app window of the ongoing online conference.

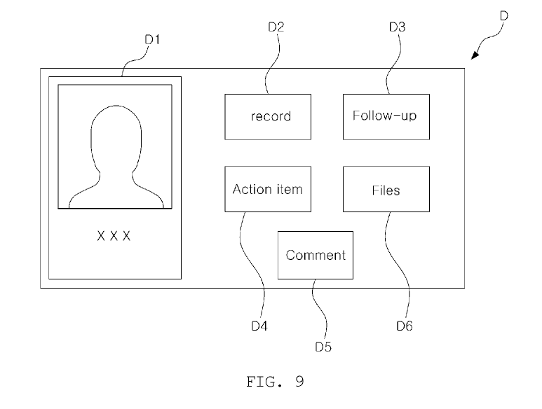

FIG. 8 shows a configuration diagram of the post-conference management module 13 of the online conference system according to the embodiment of the present invention, and FIG. 9 is a view showing an example of information stored and managed by the post-conference management module 13, and which is displayed by using the application program installed in the participant terminal.

The post-conference management module 13 is a module that stores and manages online conference information of a finished online conference after the online conference. Referring to FIG. 8, the post-conference management module 13 may include a conference result management part 131, a post-conference status management part 132, an additional agenda management part 133, a post-conference review reply management part 134, and a post-conference data management part 135.

The conference result management part 131 stores and manages a conference result including any one or more of the agenda voting result collected by the agenda voting management part 123, the conference record generated by the conference record generation part 124, and the comment input through the comment management part 126.

The conference result management part 131 may include a conference result collection part 1311, a minutes generation part 1312, a conference result DB 1313, and a conference result transmitting part 1314.

The conference result collection part 1311 collects any one or more of the agenda voting result collected by the agenda voting management part 123, the conference record generated by the conference record generation part 124, and the comment input through the comment management part 126. In other words, the conference result collection part 1311 receives the agenda voting result, statement voice recording files of the participants, statement video recording files of the participants, anonymous/by name input comments, which are received from the agenda voting collection part 1232, the voice recording part 1241, the video recording part 1242, and the comment input part 1262.

The minutes generation part 1312 generates a minutes based on the conference record. The minutes generation part 1312 may generate the minutes in a pre-defined format. In addition, it is preferable for the minutes generation part 1312 to include a speech-to-text (STT) function included in the voice recording part 1241 and the video recording part 1242 to automatically convert voice data into text data, in other words, an automatic voice-to-text conversion function.

The conference result DB 1313 is a database that stores the conference result collected by the conference result collection part 1311 and the minutes generated by the minutes generation part 1312. Post-conference actions related to the finished online conference may be efficiently managed by using data stored in the conference result DB 1313.

The conference result transmitting part 1314 transmits the conference result stored in the conference result DB 1313 to the participants so that the participants may read the conference result. As shown in FIG. 9, when an interface is provided after the online conference on an app window D of the participant terminal in which the application program is installed, the conference result transmitting part 1314 may provide the conference result in a file as shown in an upper central part D2 of the app window D while the authentication of the participant is performed through logging-in as shown in the left part D1 of the app window D. It may be configured that the participant may store the conference result transmitted by the conference result transmitting part 1314 in his or her participant terminal 3.

The post-conference status management part 132 stores and manages post-conference progress status information related to the conference result. The post-conference status management part 132 may include a post-conference status DB 1321, a post-conference status update part 1322, and a post-conference status transmitting part 1323. According to a conventional online conference solution, it is difficult to be provided with a tool for managing post-conference actions after the online conference has been finished. The above problem may be solved by using the post-conference status management part 132.

The post-conference status DB 1321 is a database that stores an item requiring a post-update among the conference results stored in the conference result DB 131. Since all of the conference results stored in the conference result DB 1313 are not required to be managed afterwards, only items requiring post-updates are stored in the post-conference status DB 1321 for efficient management.

When post-conference actions for post-update requiring items stored in the post-conference status DB 1321 are performed, the post-conference status update part 1322 reflects the performed post-conference actions, and updates the post-conference status DB 1321. If necessary, it may be set that the post-conference status update part 1322 may be accessed and manipulated by only the conference host of the online conference.

The post-conference status transmitting part 1323 transmits post-conference status information stored in the post-conference status DB 1321 to the participants so that the participant may read the post-conference status information. As shown in FIG. 9, when the interface is provided on the app window D of the participant terminal in which the application program is installed after the online conference, the post-conference status transmitting part 1323 may provide post-conference status information as shown in an upper right part D3 of the app window D while the authentication of the participant is performed through logging-in as shown in the left part D1 of the app window D. It may be configured that the participant may store the post-conference status information transmitted by the post-conference status transmitting part 1323 in his or her participant terminal 3.

The additional agenda management part 133 stores and manages the additional agenda generated by the additional agenda generation part 127. The additional agenda management part 133 may include an additional agenda DB 1331, a process status update part 1332, and a process status transmitting part 1333. According to a conventional online conference solution, it is difficult to be provided with a tool for managing a post-conference procedure of the agenda newly derived during the online conference. The above problem may be solved by using the additional agenda management part 133.

The additional agenda DB 1331 is a database that stores the additional agenda registered by the additional agenda registration part 1272. The additional agenda is stored and managed additional agenda DB 1331 since the additional agenda is an item requiring a new conference related thereto.

When post-conference actions for additional agenda management items stored in the additional agenda DB 133 are performed, the process status update part 1332 reflects the performed post-conference actions, and updates the additional agenda DB 1331. If necessary, the process status update part 1332 may be set to be accessed and manipulated by only the conference host of the online conference.

The process status transmitting part 1333 transmits the additional agenda management items stored in the post-conference status DB 1321 to the participants so that the participant may read the additional agenda management items. As shown in FIG. 9, when the interface is provided after the online conference on the app window D of the participant terminal in which the application program is installed, the process status transmitting part 1333 may provide process status information as shown in a central part D4 of the app window D while the authentication of the participant is performed through logging-in as shown in the left part D1 of the app window D. It may be configured that the participant may store the additional agenda management items transmitted by the process status transmitting part 1333 in his or her participant terminal 3.

The post-conference review reply management part 134 receives input of a post-conference comment of the participant related to the finished online conference, and stores and manages the received post-conference comment. The post-conference review reply management part 134 may include a post-conference review reply receiving part 1341, and a post-conference review reply DB 1342.

The post-conference review reply receiving part 1341 receives a post-conference comment for the conference result from the participant who has attended the online conference. As shown in FIG. 9, when the interface is provided after the online conference on the app window D of the participant terminal in which the application program is installed, the post-conference review reply receiving part 1341 may receive the post-conference comment through an interface provided with a post-conference review reply button D5 as shown in a lower part of the app window D and by clicking the button while the authentication of the participant is performed through logging-in as shown in the left part D1 of the app window D. If necessary, the post-conference comment may be input anonymously or by name.

The post-conference review reply DB 1342 is a database that stores the post-conference comment received by the post-conference review reply receiving part 1341. The post-conference comment may be stored anonymously or by name. It may be set that the conference host who conducts the online conference may have the authority to check which participant has anonymously input the post-conference comment.

The conference data post-conference management part 135 stores and manages conference data handled in the online conference. The post-conference data management part 135 may include a post-conference data DB 1351, and a post-conference data transmitting part 1352. According to a conventional online conference solution, the conference data is generally and personally kept by the participants after the online conference has been finished. However, the participants may share the conference data related to the finished online conference the post-conference data management part 135.

The post-conference data DB 1351 is a database that stores conference data that has been handled in the online conference, in other words, post-conference data. The post-conference data DB 1351 may store document data, multimedia data, etc. which was handled in the online conference.

The post-conference data transmitting part 1352 transmits the conference data to the participant who attended the online conference. As shown in FIG. 9, when the interface is provided after the online conference on the app window D of the participant terminal in which the application program installed, the post-conference data transmitting part 1352 may provide the post-conference data as shown in a central right part D6 of the app window D while the authentication of the participant is performed through logging-in as shown in the left part D1 of the app window D. It may be set that the participant may store the conference data transmitted by the post-conference data transmitting part 1352 in his or her participant terminal 3.

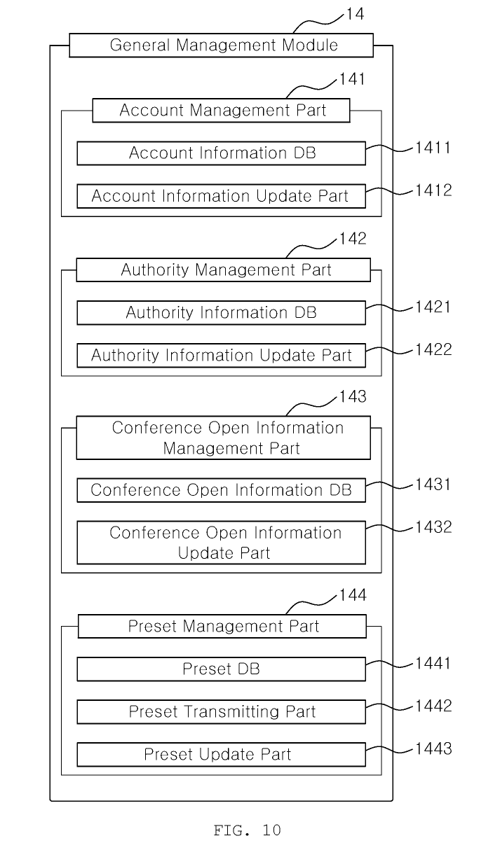

The general management module 14 manages user information of the online conference system according to the present invention, the pre-conference management module 11, the conference process module 12, and the post-conference management module 13, rather than user information of a specific online conference. FIG. 10 shows a configuration diagram of the general management module 14. Referring to FIG. 10, the general management module 14 may include an account management part 141, an authority management part 142, a conference open information management part 143, and a preset management part 144.

The account management part 141 manages account information of users of the online conference system according to the present invention. The account management part 141 may include an account information DB 1411, and an account information update part 1412.

The account information DB 1411 is a database that stores the user account information of the online conference system. In detail, the account information DB 1411 may store an ID, a password, a department, terminal information, etc. of each user. The user account information may be generated when an interface for the online conference system is provided as the application program, and the user installs and executes the application program in his or her terminal, and performs a member registration procedure.

The account information update part 1412 updates the account information DB 1411. When account information of an existing user has been changed or a new member has been registered, the account information update part 1412 reflects the changed or added account information on the account information DB 1411.

The authority management part 142 manages the authority of the users of the online conference system. The authority management part 142 may include an authority information DB 1421, and an authority information update part 1422.

The authority information DB 1421 is a database storing user authority information of the online conference system. The authority information may refer to a personal authority capable of accessing the authority information or updating the authority information in the online conference system, an authority for set-up changing or maintenance of the pre-conference management module 11, the conference process module 12, and the post-conference management module 13, etc.

The authority information update part 1422 updates the authority information DB 1421. When authority information of an existing user has been changed, or a new user with the authority has been introduced, the authority information update part 1422 reflects the changed or added authority information on the authority information DB 1421.

The conference open information management part 143 manages an independent online conference status opened in the online conference system. The conference open information management part 143 may include a conference open information DB 1431, and a conference open information update part 1432.

The conference open information DB 1431 is a database that stores status information of the online conference opened in the online conference system. In the present invention, the online conference is managed not only in real-time during the online conference, but also is managed before and after the online conference. Accordingly, the conference open information DB 1431 stores information of online conferences that are scheduled to be conducted, and online conferences that have finished but post-conference management thereof are still being conducted.

The conference open information update part 1432 updates the conference open information DB 1431. When open information related to the online conference is changed or added such as opening a new online conference in the online conference system, the conference open information update part 1432 reflects the changed or added conference open information on the conference open information DB 1431.

The preset management part 144 stores and manages formats of the online conference which may be conducted in the online conference system. In the case of a conference following a formal procedure, efficiency may be enhanced by using an existing format. The conference host may efficiently conduct the online conference by being provided with a preset formal online conference format. In other words, when the conference host wants to conducts an online conference with a specific format, according to the preset methods, a configuration setting for the pre-conference management module 11, the conference process module 12, and the post-conference management module 13 may be performed according to the preset format.

The preset management part 144 may include a preset DB 1441, a preset transmitting part 1442, and a preset update part 1443.

The preset DB 1441 is a database that stores presets that are formal online conference formats that may be conducted in the online conference system. In detail, for example, with regard to the development of medical devices, the preset may be a development kick-off conference, an input confirm conference, an output confirm conference, a verification confirm conference, a validation confirm conference, a transfer confirm conference, a launching pre-conference, etc. With regard to general conference, the preset may be a hospital staff conference, an enterprise regular conference, a sales-customer video conference, a research and design review conference, a promotion information guiding conference, etc.

The preset transmitting part 1442 provides the preset stored in the preset DB 1441 to the conference host who conducts the online conference. The preset transmitting part 1442 provides an interface to a user for checking the presets stored in the preset DB 1441 and select the preset. The interface may be provided by the app window of the application program that is described before. For example, when the conference host requests to conducts a development kick-off conference with regard to the development of medical device, the preset transmitting part 1442 may provide a development kick-off conference preset, and the conference host may set and manage each configuration of the pre-conference management module 11, the conference process module 12, and the post-conference management module 13 according to a preset setting value included in the development kick-off conference preset. Thus, the conference host may conduct the online conference that is optimized for the characteristic of the development kick-off conference.

The preset update part 1443 updates the preset DB 1441. When preset information related to the preset is changed or added by opening a new online conference in the online conference system, the preset update part 1443 reflects the changed or added preset information on the preset DB 1441.

The conference host terminal 2 is a terminal through which the conference host conducting the online conference system may input and manipulate information that is stored and managed by the conference server 1. The conference host terminal 2 may be implemented by using any device capable of performing computing by being connected to the conference server 1 through a wired/wireless communication network, such as a smart-phone, a notebook computer, a laptop computer, etc. FIG. 11 shows a configuration diagram of the conference host terminal 2 of the online conference system according to the embodiment of the present invention. Referring to FIG. 11, the conference host terminal 2 includes a pre-conference management interface providing module 21, a conference process management interface providing module 22, a post-conference management interface providing module 23, and a general management interface providing module 24.

It is preferable for the pre-conference management interface providing module 21, the conference process management interface providing module 22, the post-conference management interface providing module 23, and the general management interface providing module 24 to be implemented in a method of being installed and executed as the application program described in connection with the respective configurations of the conference server 1.

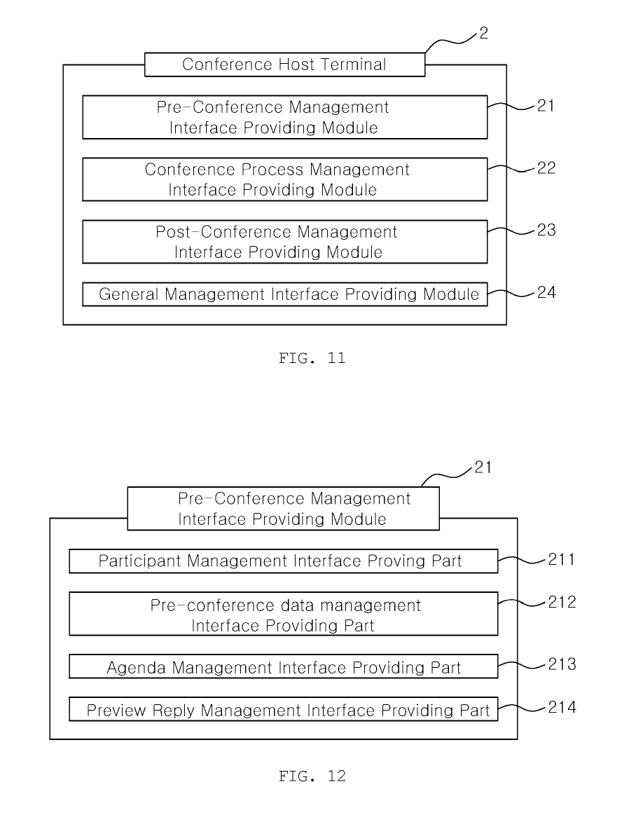

The pre-conference management interface providing module 21 is a module that provides a management interface related to a scheduled online conference. The pre-conference management interface providing module 21 may provide a management interface for the pre-conference management module 11. Referring to FIG. 12, the pre-conference management interface providing module 21 may include a participant management interface proving part 211, a pre-conference data management interface providing part 212, an agenda management interface providing part 213, and a preview reply management interface providing part 214.

The participant management interface proving part 211 provides a management interface for information of the participant who will attend the online conference. The participant management interface proving part 211 provides a management manipulation interface for the participant management part 111 so that the conference host may manage information of the participant who will attend the online conference. The participant management interface proving part 211 provides an interface for inputting new information, and changing and removing information stored in the participant DB 111, and an interface for selecting an attendance request method performed by the attendance request transmitting part 1112, and setting an attendance request.

The pre-conference data management interface providing part 212 provides a management interface for conference data that will be handled in the online conference. The pre-conference data management interface providing part 212 provides a management manipulation interface for the pre-conference data management part 112 so that the conference host may manage the conference data that will be handled in the online conference. The pre-conference data management interface providing part 212 provides an interface for inputting new conference data to the conference data DB 1121, or changing and removing the stored conference data, and an interface for selecting a transmission method of the conference data transmitted by the conference data transmitting part 1122, and selecting a transmission period.

The agenda management interface providing part 213 provides a management interface for a voting subject agenda of the online conference. The agenda management interface providing part 213 provides a management manipulation interface for the agenda management part 113 so that the conference host may manage the voting subject agenda of the online conference. The agenda management interface providing part 213 provides an interface for inputting new information to the agenda DB 1131, and changing and removing stored information, and an interface for selecting an agenda transmission method transmitted by the agenda transmitting part 1132, and setting a transmission period.

The preview reply management interface providing part 214 provides a management interface for any one or more of the reply of the participant for the attendance request and the comment of the participant for the agenda. The preview reply management interface providing part 214 provides a management manipulation interface for the preview reply management part 114 so that the conference host may manage any one or more of the reply of the participant for the attendance request and the comment of the participant for the agenda. The preview reply management interface providing part 214 provides an interface for checking the preview reply received by the preview reply receiving part 1141, and an interface for inputting new information to the preview reply DB 1142, and changing and removing of stored information.

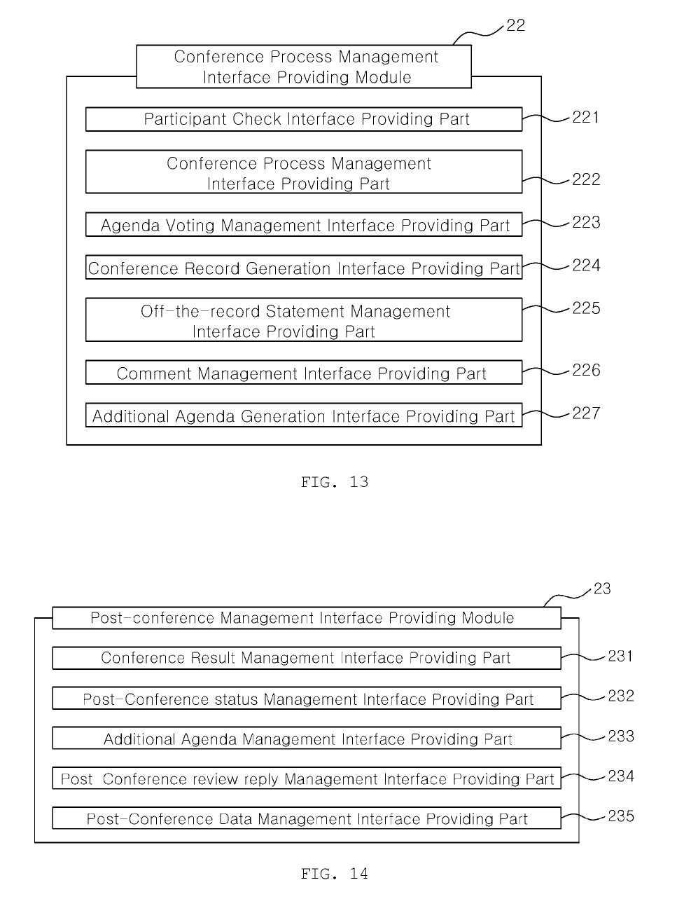

The conference process management interface providing module is a module that provides a conference process management interface for the ongoing online conference. The conference process management interface providing module 22 may provide a management interface for the conference process module 12. Referring to FIG. 13, the conference process management interface providing module 22 may include a participant check interface providing part 221, a conference process management interface providing part 222, an agenda voting management interface providing part 223, a conference record generation interface providing part 224, an off-the-record statement management interface providing part 225, a comment management interface providing part 226, and an additional agenda generation interface providing part 227.

The participant check interface providing part 221 provides an interface for checking participants of the online conference. The participant check interface providing part 221 may provide a manipulation interface for the participant check part 121 to the conference host of the online conference. The participant check interface providing part 221 provides an interface for checking participant recognition data generated by the participant recognition part 1211, and participant authentication data generated by the participant authentication part 1212.

The conference process management interface providing part 222 provides an interface for conducting the online conference. The conference process management interface providing part 222 provides a management manipulation interface for the conference process management part 122 to the conference host. The conference process management interface providing part 222 provides an interface to the conference host for conducting various events related to the process of the online conference through the process management part 1221, and an interface for generating and displaying process progress information through the process progress display part 1222.

The agenda voting management interface providing part 223 provides a management interface related to the agenda voting performed in the online conference. The agenda voting management interface providing part 223 may provide a management manipulation interface for the agenda voting management part 123 to the conference host. The agenda voting management interface providing part 223 provides an interface for manipulating and managing the agenda voting generation part 1231 and the agenda voting collection part 1232, and also provides an interface for setting the agenda voting generation part 1231 and the agenda voting collection part 1232 so that the agenda voting and result collection thereof are performed anonymously or by name.

The conference record generation interface providing part 224 provides an interface related to a generation of the conference record of the ongoing online conference. The conference record generation interface providing part 224 may provide a management manipulation interface for the conference record generation part 124 to the conference host. The conference record generation interface providing part 224 provides an interface for controlling and manipulating the voice recording part 1241 and the video recording part 1242.

The off-the-record statement management interface providing part 225 provides a management interface for the off-the-record statement of the ongoing online conference. The off-the-record statement management interface providing part 225 may provide a management manipulation interface for the off-the-record statement management part 125 to the conference host. The off-the-record statement management interface providing part 225 provides an interface for setting the condition decision part 1251 that is related to an off-the-record statement generation condition, and for setting an operation method of the conference record generation stopping part 1252.

The comment management interface providing part 226 provides a management interface related to a comment of the participant of the ongoing online conference. It is preferable for the comment management interface providing part 226 to provide a management interface so that the participant of the ongoing online conference may input the comment anonymously. The comment management interface providing part 226 may provide a management manipulation interface for the comment management part 126 to the conference host. The comment management interface providing part 226 provides an interface for setting the anonymous/by name selection part 1261, and for setting the comment input part 1262.

The additional agenda generation interface providing part 227 provides a generation interface for the additional agenda generated in the ongoing online conference. The additional agenda generation interface providing part 227 may provide a management manipulation interface for the additional agenda generation part 127 to the conference host. The additional agenda generation interface providing part 227 provides a manipulation and set-up interface for the additional agenda input part 1271 and the additional agenda registration part 1272.

The post-conference management interface providing module 23 is a module that provides a management interface related to the finished online conference. The post-conference management interface providing module 23 may provide a management interface for the post-conference management module 13. Referring to FIG. 14, the post-conference management interface providing module 23 may include a conference result management interface providing part 231, a post-conference status management interface providing part 232, an additional agenda management interface providing part 233, a post-conference review reply management interface providing part 234, and a post-conference data management interface providing part 235.

The conference result management interface providing part 231 provides a management interface for the conference result for the finished online conference. The conference result management interface providing part 231 may provide a management manipulation interface for the conference result management part 131 to the conference host. The conference result management interface providing part 231 provides an interface related to a collection method of the conference result performed by the conference result collection part 1311, setting related to the minutes generation performed by the minutes generation part 1312, updating of the conference result DB 1313, and setting of the conference result transmitting part 1314.

The post-conference status management interface providing part 232 provides a management interface for post-conference status management items that require a post-conference action among the conference results of the finished online conference. The post-conference status management interface providing part 232 may provide a management manipulation interface for the post-conference status management part 132 to the conference host. The post-conference status management interface providing part 232 provides an interface for manipulating and setting the post-conference status DB 1321, the post-conference status update part 1322, and the post-conference status transmitting part 1323. In other words, the conference host may select the post-conference status management items among the conference results stored in the conference result DB 1313 trough the post-conference status management interface providing part 232, and the selected items may be stored in the post-conference status DB 1321. The post-conference status DB 1321 may be updated based on post-conference actions of the selected items, and the result may be transmitted through the post-conference status transmitting part 1323.

The additional agenda management interface providing part 233 provides a management interface for a generated additional agenda of the finished online conference. The additional agenda management interface providing part 233 may provide a management manipulation interface for the additional agenda management part 133 to the conference host. The additional agenda management interface providing part 233 provides an interface for updating the additional agenda DB 1331, manipulating and setting the process status update part 1332, and manipulating and setting the process status transmitting part 1333. In other words, the additional agenda management interface providing part 233 causes the conference host to generate process status information for the additional agenda stored in the additional agenda DB 1331 through the process status update part 1332, to update the additional agenda DB 1331, and to transmit the corresponding result to through the process status transmitting part 1333.

The post-conference review reply management interface providing part 234 provides a management interface for a post-conference review reply of the participant related to the conference result of the finished online conference. The post-conference review reply management interface providing part 234 may provide a management manipulation interface for the post-conference review reply management part 134 to the conference host. The post-conference review reply management interface providing part 234 provides an interface for setting a receiving environment of the post-conference review reply receiving part 1341, checking and processing the received post-conference review reply, and updating the post-conference review reply DB 1342.

The post-conference data management interface providing part 235 provides a management interface for the conference data handled in the finished online conference, in other words, post-conference data. The post-conference data management interface providing part 235 may provide a management manipulation interface for the conference data post-conference management part 135 to the conference host. The post-conference data management interface providing part 235 provides an interface for updating the post-conference data DB 1351, and manipulating and setting the post-conference data transmitting part 1352.

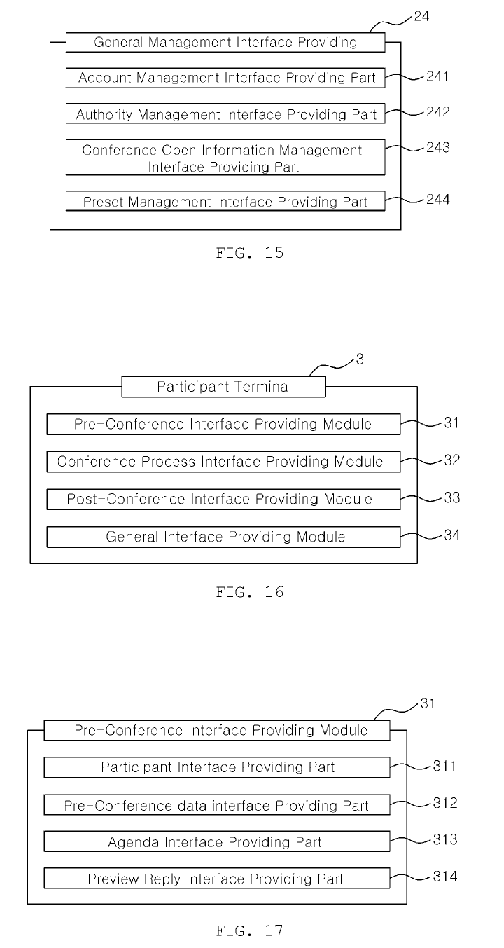

The general management interface providing module 24 is a module that provides an interface related to a general management. The general management interface providing module 24 may provide a management interface for the general management module 14. Referring to FIG. 15, the general management interface providing module 24 may include an account management interface providing part 241, an authority management interface providing part 242, a conference open information management interface providing part 243, and a preset management interface providing part 244.

The account management interface providing part 241 provides an interface related to an account management. The account management interface providing part 241 may provide a management manipulation interface for the account management part 141 to the conference host. The account management interface providing part 241 provides an interface for setting and manipulating the account information update part 1412, and updating the account information DB 1411 based on the account information update part 1412.

The authority management interface providing part 242 provides an authority management interface for the conference host and the participants. The authority management interface providing part 242 may provide a management manipulation interface for the authority management part 142 to the conference host. The authority management interface providing part 242 provides an interface for setting and manipulating the authority information update part 1422, and updating the authority information DB 1421 based on the authority information update part 1422.

The conference open information management interface providing part 243 provides a management interface for conference open information of the opening online conference. The conference open information management interface providing part 243 may provide a management manipulation interface for the conference open information management part 143 to the conference host. The conference open information management interface providing part 243 provides an interface for setting and manipulating the conference open information update part 1432, and updating the open information DB 1431 based on the conference open information update part 1432.

The preset management interface providing part 244 provides a preset management interface for various online conferences. The preset management interface providing part 244 may provide a management manipulation interface for the preset management part 144 to the conference host. The preset management interface providing part 244 provides an interface for setting and manipulating the preset update part 1443, updating the preset DB 1441 based on the preset update part 1443, and setting and manipulating the preset transmitting part 1442. Particularly, when a conference host wants to conduct an online conference having a specific preset stored in the preset DB 1441, the preset transmitting part 1442 provides the corresponding preset to the conference host. Herein, it is preferable to provide an interface for executing the preset transmitted by the preset transmitting part 1442. Herein, setting of each configuration of the pre-conference management interface providing module 21, the conference process management interface providing module 22, and the post-conference interface providing module 23 may be automatically performed according to values of the corresponding preset.

The participant terminal 3 is a terminal through which the participant may be provided with various types of information related to the online conference through the online conference system, and may attend the online conference. The participant terminal 3 may be implemented by using any device capable of performing computing by being connected to the conference server 1 through a wired/wireless communication network, such as a smart-phone, a notebook computer, a laptop computer, etc. FIG. 16 shows a configuration diagram of the participant terminal 3 of the online conference system according to the embodiment of the present invention. Referring to FIG. 16, the participant terminal 3 may include a pre-conference interface providing module 31, a conference process interface providing module 32, a post-conference interface providing module 33, and a general interface providing module 34.

It is preferable for the pre-conference interface providing module 31, the conference process interface providing module 32, the post-conference interface providing module 33, and the general interface providing module 34 to be implemented in a method of being installed and executed as the application program described in connection with the respective configurations of the conference server 1.

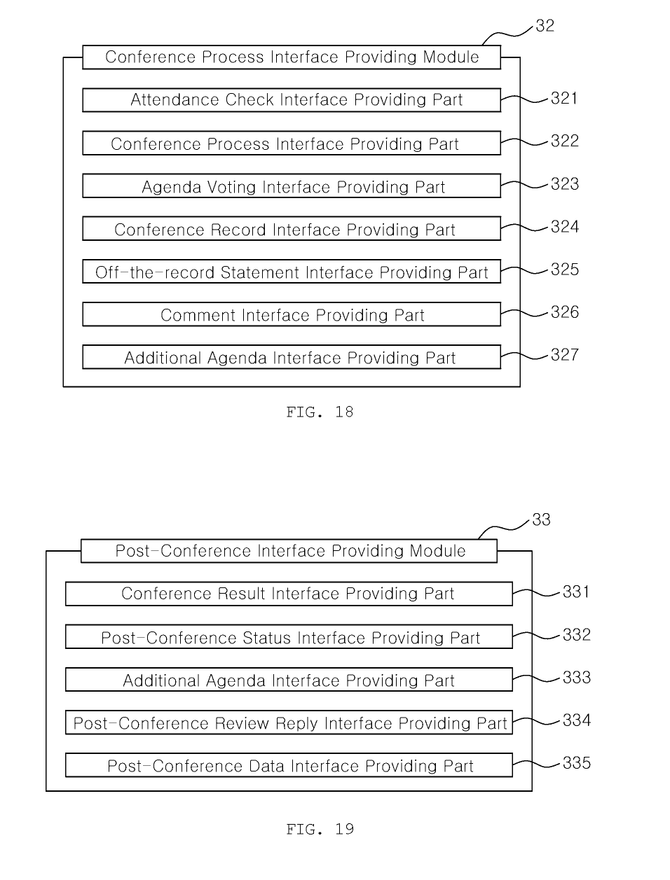

The pre-conference interface providing module 31 is a module that provides information of a scheduled online conference. The pre-conference interface providing module 31 may be provided with information of the scheduled online conference from the pre-conference management module 11. Referring to FIG. 17, the pre-conference interface providing module 31 may include a participant interface providing part 311, a pre-conference data interface providing part 312, an agenda interface providing part 313, and a preview reply interface providing part 314.

The participant interface providing part 311 provides an interface related to an attendance of the scheduled online conference to the participant who will attend the online conference. The participant interface providing part 311 provides an interface to the participant for checking the attendance request transmitted by the attendance request transmitting part 1112.

The pre-conference data interface providing part 312 provides an interface to the participant for checking in advance conference data that will be handled in the online conference. The pre-conference data interface providing part 312 may provide an interface for checking the conference data transmitted by the conference data transmitting part 1122, and an interface for downloading the conference data. The pre-conference data interface providing part 312 may provide a pre-conference data interface as shown in a lower central part A2 of the app window A of FIG. 4.

The agenda interface providing part 313 provides an interface to the participant for checking in advance a voting subject agenda of the scheduled online conference. The agenda interface providing part 313 may provide an interface for checking the agenda transmitted by the agenda transmitting part 132, and an interface for downloading the agenda. The agenda interface providing part 313 may provide an agenda interface as shown in a right upper part A3 of the app window A of FIG. 4.

The preview reply interface providing part 314 provides an interface to the participant for inputting and transmitting the reply of the participant for the attendance request, and the comment of the participant for the agenda. The preview reply interface providing part 314 provides an interface for inputting the reply for the attendance request or the comment for the agenda, and for transmitting the input reply or comment to the replay receiving part 1141. The preview reply interface providing part 314 may provide an interface for inputting a pre-comment as the preview reply input button A4 as shown in the lower right part of the app window A of FIG. 4.

The conference process interface providing module 32 is a module that provides information related to the ongoing online conference. The conference process interface providing module 32 may be provided with information of the scheduled online conference from the conference process module 12. Referring to FIG. 18, the conference process interface providing module 32 may include an attendance check interface providing part 321, a conference process interface providing part 322, an agenda voting interface providing part 323, a conference record interface providing part 324, an off-the-record statement interface providing part 325, a comment interface providing part 326, and an additional agenda interface providing part 327.

The attendance check interface providing part 321 provides an interface to the participant for checking an attendance of the online conference. The attendance check interface providing part 321 provides an interface for checking the participant attendance of the online conference performed by the participant recognition part 1211, and an interface for the electronic identification or the biometric recognition method performed by the participant authentication part 1212.

The conference process interface providing part 322 provides to the participant an interface related to conducting the ongoing online conference. The conference process management interface providing part 222 provides an interface to the participant for checking various types of information related to the ongoing online conference. The conference process interface providing part 322 may show a current speaker as shown in the left part B1 of the app window B of FIG. 6, or an agenda being currently discussed as shown in the upper right part B3 of the app window B of FIG. 6, or may provide an interface for checking the conference data as shown in the central part B4 of the app window B. In addition, as shown in FIGS. 6 and 7, progress bars B5 and C1 showing a progress state may be provided in respective upper parts of the App windows.

The agenda voting interface providing part 323 provides an interface to the participant for agenda voting performed in the ongoing online conference. The agenda voting interface providing part 323 displays an agenda voting interface generated by the agenda voting generation part 1231 on the participant terminal 3, and may also display a voting collection result performed by the agenda voting collection part 1232 depending on the setting. The agenda voting interface providing part 323 may provide an agenda voting interface as shown in an app window C of FIG. 7.

The conference record interface providing part 324 provides to the participant an interface related to generating the conference record of the ongoing online conference. In general, the participant who is not the conference host may not arbitrarily control the generation of the conference record. Herein, the conference record interface providing part 324 may provide to the participant a mark informing that the conference record is being generated by voice recording or video recording.

The off-the-record statement interface providing part 325 provides an interface to the participant for requesting and inputting the off-the-record statement. The off-the-record statement interface providing part 325 may provide an interface for requesting an off-the-record statement as the off-the-record statement request button B6 of the app window B shown in FIG. 6.

The comment interface providing part 326 provides an interface to the participant for inputting a comment related to the agenda. It is preferable for the comment interface providing part 326 to provide an interface through which the participant of the ongoing online conference may input the comment anonymously. The comment management interface providing part 226 provides an interface for selecting whether to input the comment anonymously or by name, and for inputting the comment.

The additional agenda interface providing part 327 provides an interface for notifying an additional agenda additionally derived during the online conference to the participant. The additional agenda generation interface providing part 227 displays the additional agenda that is input through the additional agenda input part 1271 and registered by the additional agenda registration part 1272 by changing into text so that the participant may check the additional agenda.

The post-conference interface providing module 33 is a module that provides information related to the finished online conference. The information related to the finished online conference may be provided by the post-conference management module 13. Referring to FIG. 19, the post-conference interface providing module 33 may include a conference result interface providing part 331, a post-conference status interface providing part 332, an additional agenda interface providing part 333, a post-conference review reply interface providing part 334, and a post-conference data interface providing part 335.

The conference result interface providing part 331 provides an interface to the participant for checking a conference result of the finished online conference. The conference result interface providing part 331 provides an interface for checking the conference result transmitted by the conference result transmitting part 1314. The conference result interface providing part 331 may provide the conference result in a file as shown in the upper central part D2 of the of the app window D of FIG. 9, or may provide an interface for downloading the conference result

The post-conference status interface providing part 332 provides an interface to the participant for checking a post-conference status related to the conference result of the finished online conference. The post-conference status interface providing part 332 provides an interface for checking a post-conference status transmitted by the post-conference status transmitting part 1323. The post-conference status interface providing part 332 may provide post-conference status information as shown in the upper right part D3 of the app window D of FIG. 9, or may provide an interface for downloading the post-conference status information.

The additional agenda interface providing part 333 provides an interface to the participant for checking items related to a derived additional agenda of the finished online conference. The additional agenda interface providing part 333 provides an interface for checking a process status of the additional agenda transmitted by the process status transmitting part 1333. The additional agenda interface providing part 333 may provide process status information as shown in the central part D4 of the app window D of FIG.9, or may provide an interface for downloading the process status of the additional agenda.

The post-conference review reply interface providing part 334 provides an interface to the participant for inputting and transmitting a post-conference comment related to the finished online conference. The post-conference review reply interface providing part 334 provides an interface for receiving a post-conference comment input and transmitting the received input to the post-conference review reply receiving part 1341. The post-conference review reply interface providing part 334 may provide an interface with a form of the post-conference review reply input button as shown in the lower part of the app window D of FIG. 9.

The post-conference data interface providing part 335 provides an interface to the participant for checking conference data handled in the finished online conference. The post-conference data interface providing part 335 provides an interface for checking the conference data transmitted by the post-conference data transmitting part 1352. The post-conference data interface providing part 335 may provide post-conference data as shown in the central right part D6 of the app window D of FIG. 9, or may provide an interface for downloading the same.

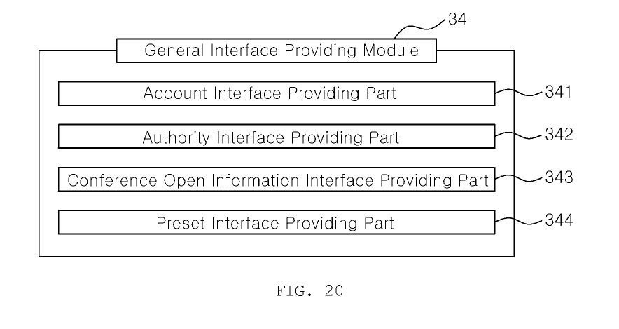

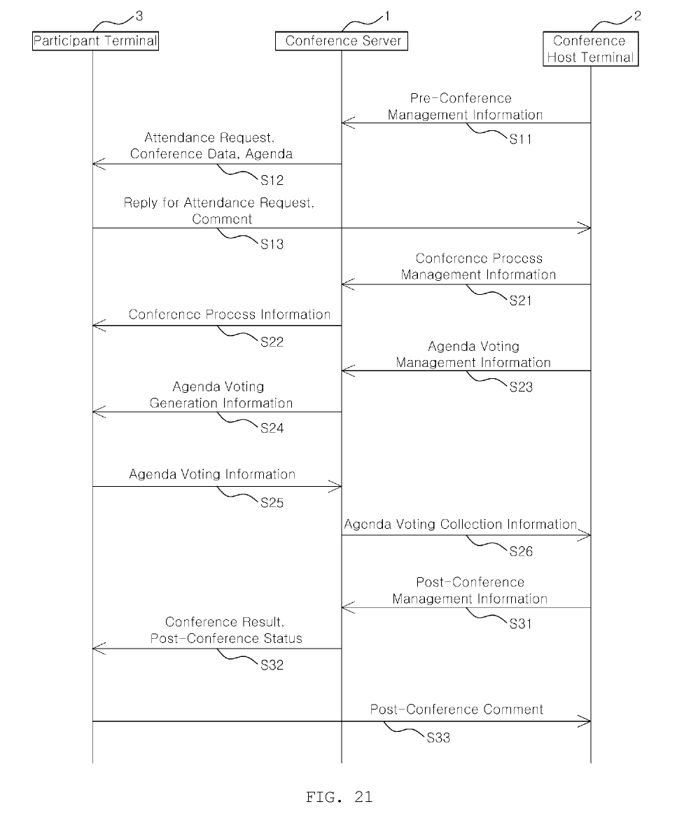

The general interface providing module 34 is a module that is provided with information of a general management from the general management module 14. Referring to FIG. 20, the general interface providing module 34 may include an account interface providing part 341, an authority interface providing part 342, a conference open information interface providing part 343, and a preset interface providing part 344.

The account interface providing part 341 provides to the participant an interface related to an account of the online conference system. The account interface providing part 341 may provide an interface to the participant for a member registration, logging-in, changing of member information, etc.

The authority interface providing part 342 provides an interface to the participant for checking data related to his or her authority. In the present invention, the conference host and the participant have different access and operation authority for each configuration of the conference server 1. If necessary, an interface for requesting an extension or reduction of the authority may be provided. When the participant makes an application related to the authority through the authority interface providing part 342, the conference host may process the application through the authority management interface providing part 242. Meanwhile, the authority interface providing part 342 may not be included in the general interface providing module 34.

The conference open information interface providing part 343 provides an interface to the participant for checking online conference information opened in the online conference system. It is preferable for the conference open information interface providing part 343 to provide online conference information to a general participant who has received an attendance request or has attended before in connection with the security.

The preset interface providing part 344 provides an interface to the participant for checking preset information related to the online conference. Since a general participant does not personally open an online conference, the preset interface providing part 344 may not be provided in the general interface providing module 34. If necessary, it may be configured to only provide a preset sample for a promotion or a promotion of the online conference system.

FIG. 21 shows an example view of the online conference conducted in the online conference system according to the embodiment of the present invention. The example of the online conference conducted in the online conference system according to the embodiment of the present invention will be described with reference to FIG. 21.

Before the online conference, in step S11, the conference host terminal 2 transmits pre-conference management information to the conference server 1. The pre-conference management information is information for a scheduled online conference, in other words, the pre-conference management information may include a participant, conference data, an agenda, etc. In step S12, the conference server 1 opens an online conference based on the pre-conference management information, and transmits an attendance request, conference data, and an agenda to a participant terminal 3 of the scheduled online conference. In step S13, in response to the transmission, the participant terminal 3 transmits a reply for the attendance request, a comment for the agenda to the conference host terminal 2 by passing through the conference server 1.

During the online conference, in step S21, the conference host terminal 2 transmits conference process management information related to the ongoing online conference to the conference server 1. In step S22, the conference server 1 transmits conference process information based on the transmitted conference process management information to the participant terminal 3. In addition, when voting on the agenda is performed during the online conference, in step S23, the conference host terminal 2 transmits agenda voting management information to the conference server 1, and in step S24, the conference server 1 generates an agenda voting based on the transmitted agenda voting management information, and transmits the generated agenda voting to the participant terminal 3. Then, in step S25, the participant terminal 3 transmits agenda voting information that is information for the agenda which has been done by the participant to the conference server 1. In step S26, the conference server 1 collects the agenda voting information, and transmits agenda voting collection information to the conference host terminal 2.

After the online conference, in step S31, the conference host terminal 2 transmits post-conference management information to the conference server 1. The post-conference management information may include a conference result of the finished online conference, a post-conference status which means a post-conference process progress status of the conference result, etc. In step S32, the conference server 1 transmits the conference result and the post-conference status to the participant terminal 3, and in step S33, the participant terminal 3 transmits a post-conference comment for the conference result and the post-conference status to the conference host terminal 2 by passing through the conference server 1.

Meanwhile, according to another embodiment of the present invention, the conference server 1 and the conference host terminal 2 may be integrally configured. In other words, transmitting and receiving of information related to an online conference may be performed through a direct communication between the conference host terminal 2 and the participant terminal 3 since the conference server 1 is included in a local area of the conference host terminal 2.

Although the applicant(s) have described various example embodiments, the example embodiments are only an example to achieve the technical spirit of the present disclosure and thus, it would be appreciated by those skilled in the art that changes or modifications may be made to the example embodiments without departing from the principles and spirit of the present disclosure, the scope of which is defined by the claims and their equivalents.

What is claimed is:

1. An online conference system, the system comprising:
a pre-conference management module storing and managing information of a scheduled online conference before processing the online conference;
a conference process module generating information of an ongoing conference when processing the online conference; and
a post-conference management module storing and managing information of a finished online conference after processing the online conference.

2. The system of claim 1, wherein the pre-conference management module includes a participant management part storing and managing information of a participant who will attend the online conference.

3. The system of claim 2, wherein the participant management part includes an attendance request transmitting part transmitting an attendance request to the participant who will attend the online conference.

4. The system of claim 2, wherein the pre-conference management module includes a pre-conference data management part storing and managing conference data that will be handled in the online conference.

5. The system of claim 4, wherein the pre-conference management module further includes an agenda management part storing and managing a voting subject agenda of the online conference.

6. The system of claim 5, wherein the pre-conference management module further includes a preview reply management part storing and managing any one or more of a reply of the participant for the attendance request and a comment of the participant for the agenda.

7. The system of claim 6, wherein the conference process module includes a participant check part checking an attendance of the participant.

8. The system of claim 7, wherein the participant check part includes a participant authorization part checking the attendance of the participant by using an electronic identification or a biometric authorization method.

9. The system of claim 7, wherein the conference process module further includes a conference process management part generating and providing process progress information of the ongoing online conference.

10. The system of claim 9, wherein the conference process management part includes a process progress display part quantitatively displaying the process progress information.

11. The system of claim 1, wherein the conference process module further includes an agenda voting management part providing a voting interface for the agenda of the ongoing online conference, and collecting a voting result.

12. The system of claim 11, wherein the conference process module further includes a conference record generation part generating a conference record of the ongoing online conference.

13. The system of claim 12, wherein the conference record generation part includes any one or more of a voice recording part performing voice recording and a video recording part performing video recording.

14. The system of claim 12, wherein the conference process module further includes an off-the-record statement management part stopping, under a certain condition, the generation of the conference record performed by the conference record generation part.

15. The system of claim of 14, wherein the conference process module further includes a comment management part receiving a comment from a participant anonymously or by name.

16. The system of claim of 15, wherein the conference process module further includes an additional agenda generation part generating an additional agenda that is newly generated in the ongoing online conference.

17. The system of claim of 16, wherein the post-conference management module includes a conference result management part storing and managing a conference result including any one or more of the agenda voting result collected by the agenda voting management part, the conference record generated by the conference record generation part, and the comment received by the comment management part.

18. The system of claim of 17, wherein the conference result management part includes a minutes generation part generating a minutes based on the conference record.

19. The system of claim of 17, wherein the post-conference management module further includes a post-conference status management part storing and managing post-conference process status information related to the conference result.

20. The system of claim of 19, wherein the post-conference management module further includes an additional agenda management part storing and managing the additional agenda generated by the additional agenda generation part.

21. The system of claim of 20, wherein the post-conference management module further includes a post-conference review reply management part receiving post-conference comment input related to the finished online conference from the participant, and storing and managing the received comment.

22. The system of claim of 21, wherein the post-conference management module further includes a post-conference data management part storing and managing conference data handled in the online conference.

23. The system of claim 1, further comprising a conference host terminal including:
a pre-conference management interface providing module providing a management interface for the pre-conference management module;
a conference process management interface providing module providing a management interface for the conference process module; and
a post-conference management interface providing module providing a management interface for the post-conference management module.

24. The system of claim of 23, wherein the pre-conference management interface providing module includes:
a participant management interface proving part providing a management interface for information of the participant who will attend the online conference;
a pre-conference data management interface providing part providing a management interface for the conference data that will be handled in the online conference; and
an agenda management interface providing part providing a management interface for the voting subject agenda of the online conference.

25. The system of claim of 24, wherein the conference process management interface providing module includes an agenda voting management interface providing part providing a management interface related to an agenda voting performed in the online conference.

26. The system of claim of 25, wherein the conference process management interface providing module further includes a comment management interface providing part providing a comment management interface so that the participant of the online conference anonymously inputs a comment for the ongoing online conference.

27. The system of claim of 26, wherein the conference process management interface providing module further includes an additional agenda generation interface providing part providing a generation interface for the additional agenda generated in the ongoing online conference.

28. The system of claim of 27, wherein the post-conference management interface providing module includes:
a conference result management interface providing part providing a management interface for the conference result of the finished online conference;
a post-conference status management interface providing part providing a management interface for a post-conference status item that requires a post-conference action among the conference results of the finished online conference; and
an additional agenda management interface providing part providing a management interface for the generated additional agenda of the finished online conference.

29. The system of claim of 23, further comprising a participant terminal including:
a pre-conference interface providing module provided with information of the scheduled online conference from the pre-conference management module;
a conference interface providing module provided with information of the ongoing online conference from the conference process module; and
a post-conference interface providing module provided with information of the finished online conference from the post-conference management module.

30. The system of claim of 29, wherein the pre-conference interface providing module includes:
a pre-conference data interface providing part providing an interface to the participant for checking the conference data that will be handled in the online conference; and
an agenda interface providing part providing an interface to the participant for pre-checking the voting subject agenda that will be voted in the scheduled online conference.

31. The system of claim of 30, wherein the conference interface providing module includes an agenda voting interface providing part providing an interface to the participant for voting on the agenda of the ongoing online conference.

32. The system of claim of 31, wherein the conference interface providing module further includes a comment interface providing part providing an interface to the participant of online conference for anonymously inputting a comment of the ongoing online conference.

33. The system of claim of 32, wherein the post-conference interface providing module includes:
a conference result interface providing part providing an interface to the participant for checking the conference result of the finished online conference; and
a post-conference status interface providing part providing an interface to the participant for checking a post-conference status related to the conference result of the finished online conference.
